(19) United States
(12) Patent Application Publication
(10) Pub. No.: US 2015/0129638 A1
(43) Pub. Date: May 14, 2015

(54) Friction Stir Welding Tool and Method for the Production Thereof

(71) Applicant: Airbus Defense and Space GmbH, Ottobrunn (DE)

(72) Inventors: Juergen Silvanus, Unterhaching (DE); Tommy Brunzel, Meerane (DE)

(73) Assignee: Airbus Defence and Space GmbH, Ottobrunn (DE)

(21) Appl. No.: 14/405,208

(22) PCT Filed: May 28, 2013
(86) PCT No.: PCT/DE2013/000286

§ 371 Date: Dec. 3, 2014

(30) Foreign Application Priority Data
Jun. 4, 2012 (DE) 10 2012 010 916.4

(51) Int. Cl. B23K 20/12; B22F 7/02; B22F 3/15; B23P 11/02

(52) U.S. Cl. CPC B23K 20/1255; B23P 11/025; B22F 7/02; B22F 3/15
USPC 228/2.1; 29/447; 419/5

(57) ABSTRACT

A welding tool for joining at least two workpieces by friction stir welding includes a pin for applying frictional heat to the workpieces. The pin includes a first pin region formed from a first material and a second pin region formed from a second material.

### BACKGROUND AND SUMMARY OF THE INVENTION

Exemplary embodiments of the invention relate to a welding tool for joining at least two workpieces by friction stir welding and a method for manufacturing such a welding tool.

In contrast to friction welding, in friction stir welding the friction energy is not generated by the rotation of one of the workpieces to be joined relative to the other workpiece or workpieces; instead, a welding tool is used that applies the rotation energy simultaneously to the workpieces to be joined, as is described, for example in US patent document U.S. Pat. No. 4,423,619 B. The following steps are used:

In the first step, a rotating pin on the welding tool is pressed with great force between the workpieces to be joined until a shoulder of the welding tool that surrounds the pin is positioned against the surface of the workpieces.

In the second step, the rotating pin remains at the plunge location for a brief period, wherein the region between the shoulder of the welding tool and the workpieces is heated to just under the melting point of the workpieces. The material of the workpieces softens and plasticizes so that it becomes possible to mix the materials of the workpieces to be joined in a joining region.

In the third step, the welding tool is moved in the advancing direction such that the shoulder continues to be pressed with great force against the workpiece surfaces and the pin is thus pressed into the joining region. During the advancing movement, the rotational movement of the pin creates a pressure difference between the forward region of the welding tool and its back side so that plasticized material is moved about the pin, mixes, and thus contributes to forming the weld seam.

The welding tool is withdrawn from the joining region at the end of the weld seam.

Pins that are used in such welding tools are described for instance in US patent documents US 2006/0065694 A1 and U.S. Pat. No. 7,401,723 B2.

German patent document DE 10 2005 060 178 B4 describes a stir friction welding tool having a shape-adaptable shoulder.

German patent document DE 10 2009 040 526 A1 describes a stir friction welding method in which a plurality of forces are exerted by a welding tool in order not only to join the workpieces to be joined but also to simultaneously form a staggered component area during the stir friction welding.

In a stir friction welding method described in German patent document DE 10 2010 032 402, for overcoming a large gap between the workpieces to be joined, a cover plate is brought onto the seam of the workpieces and is later milled off.

German patent document DE 10 2004 030 381 B3 describes a method for online quality testing during stir friction welding, wherein process parameters such as vibrations of the pin or workpieces are monitored.

In stir friction welding, not only does the frictional heat plasticize the workpieces to be joined, it also heats the pin itself to working temperature, generally about 500° C.

Pins known until now are made from generally heat-resistant metal materials in order to be able to easily transfer the frictional heat to the workpieces to be joined. It is a problem that such pins react to forces or torques acting from outside and distort, thus rapidly becoming unusable.

The phenomenon of distortion may be countered in that a thicker pin is used, but this opposes the need to use slender pins for narrow weld seams.

Exemplary embodiments of the invention are therefore directed to an improved welding tool, as well as a method for manufacturing such a welding tool.

According to exemplary embodiments of the invention. a welding tool for joining at least two workpieces by means of friction stir welding has a pin for applying frictional heat to the workpieces, wherein the pin includes a first pin region formed from a first material and a second pin region formed from a second material.

If the first material is different from the second material, pin properties may be attained that may not be attained by using a single material. For instance, one of the two materials may stabilize the pin against distortion, while the other material has a good friction coefficient for generating frictional heat in contact with the workpieces to be joined.

The first pin region therefore preferably has a support region for supporting the pin during the friction stir welding. The second pin region further preferably has a friction region, in particular a friction surface, for applying frictional heat to the workpieces.

The first material preferably has a higher E modulus than the second material and is in particular a higher strength material. It is particularly preferred that the E modulus of the first material is greater than the E modulus of the second material by 20% to 50%. Thus, the first material preferably forms a resistance against the effects of external forces and torques and therefore advantageously contributes to the pin distorting less.

The second material is advantageously heat resistant and/or toughened so that it advantageously does not plasticize or melt at operating temperature during the friction stir welding. It is particularly preferred that the second material is heat conducting so that it can effectively apply frictional heat to the workpieces to be joined.

The first material is preferably ceramic, especially formed with Si₃N₄—Y₂O₃ or ZrO₂—Y₂O₃. In general ceramics are also dimensionally stable and hard, even at very high temperatures, i.e. preferably up to 2000° C., and therefore are well able to withstand forces and torques acting from outside.

The second material is preferably metal and includes in particular a metal material, preferably MP 159. The metal character preferably provides a heat-conducting second material that may apply the frictional heat preferably in contact with the workpieces to be joined. It is preferred that a metal composite be used, since this means that advantageous properties of the second material may be further adjusted.

Examples of suitable materials are nickel-cobalt compounds, Inconel, material used for engines, nickel compounds, cobalt compound, MP 159, TSP 1, hot work tool steels, and high-speed steels. Particularly preferred is MP 159, an alloy having especially high conductivity and preferably high stiffness, that has for instance an E modulus of about 243 GPa at room temperature and e.g. an E modulus of about 206 GPa at about 500° C.

In one particular embodiment, the first material has a higher coefficient of thermal expansion than the second material. Thus the first material especially expands at operating temperature and preferably generates an outward radial force onto the second material so that the latter is especially well stabilized. Then materials such as light metals, aluminum, and steel may also be used for the second material, for instance.

The pin preferably extends along a longitudinal axis of the welding tool, wherein a shoulder that surrounds the pin is provided for separating a joining region of the workpieces from the surroundings. The pin may advantageously be driven to rotate about the longitudinal axis. The shoulder surrounding the pin may alternatively remain fixed or may also rotate about the longitudinal axis. The shoulder may also preferably be provided as a molding tool for the joining region or may be movable along the longitudinal axis.

In order to prevent the shoulder surrounding the pin from being spattered with the plasticized material from the workpieces, the shoulder preferably has a diamond or ceramic coating, especially in the region that comes into contact with the workpieces.

The first and second pin regions are advantageously arranged rotationally symmetrical about a longitudinal axis. Thus, when the pin is rotating, a resistance force always acts against any forces and torques acting from outside, regardless of the direction from which they are applied to the pin.

The first pin region may preferably extend along the entire longitudinal axis of the pin or alternatively a part thereof may extend along the longitudinal axis. Thus alternatively preferably either the entire pin length may be stabilized or material and manufacturing costs may be saved in that only preferably a sub-region of the pin is stabilized. If only a sub-region is stabilized, it is preferred that the sub-region in which the highest flexural load is to be expected during the friction stir welding be stabilized.

The first pin region is advantageously arranged within the second pin region. For instance, the first pin region may be arranged in a sac-like recess in the second pin region. In a particularly preferred embodiment, a plurality of first pin regions may be provided in order to stabilize for instance a plurality of sub-regions of the pin against distortion.

If a plurality of first pin regions is provided, these are advantageously likewise arranged symmetrically about the longitudinal axis of the welding tool.

The pin preferably has a longer longitudinal extension length than diameter and thus preferably is slender in form. The pin is thus advantageously longer than it is thick. For instance, the pin may have a longitudinal extension length of 20 mm to 60 mm, while the exterior diameter preferably is on the order of magnitude of about 4 mm to 8 mm. For instance, a bore added to the pin, into which bore e.g. the ceramic is inserted, has a diameter of about 2 mm to 4 mm. Thus advantageously stable and yet narrow welding seams may be produced in a joining region of the workpieces to be joined.

The pin or the first pin region and/or the second pin region are preferably embodied in a conical shape. Alternatively, the pin or the first pin region and/or the second pin region may also be embodied in a cylinder shape. It is also possible for the first pin region to be embodied in a conical shape and the second pin region to be embodied in a cylinder shape and vice versa.

The pin advantageously has a polygonal outer geometry, for instance a hexagonal outer geometry, and/or a male thread.

The first and second pin regions are preferably held to one another in a positive fit. In addition or alternatively, the first and second pin regions may also be held to one another in a material bond. In this way it is possible to advantageously produce a particularly close connection of the two pin regions that are formed from different materials.

For example, the first pin region may have ribbing, notching, wave shapes, and/or another type of contouring. The second pin region advantageously has a corresponding complementary shape and thus advantageously forms a positive fit with the first pin region.

The first and second materials may also advantageously be diffused into one another in a diffusion region of the pin and thus preferably be held to one another in a material bond.

In one method for manufacturing a friction stir welding tool, first a first material and a second material are provided and a pin is formed therefrom, wherein the first material is inserted into the second material.

Advantageously, when forming the pin first the second material is heated, the first material is enclosed with this heated second material, and then the two materials are cooled together.

Alternatively, the pin may also be formed by generative production, in particular using rapid prototyping or using additive layer manufacturing or using hot isostatic pressing of powder.

Advantageously the first material is premolded, in particular in that a contouring and/or a ribbing and/or at least one notch and/or a wave shape is formed.

In a particularly preferred embodiment, the formed pin is acted upon with elevated pressure and/or with elevated temperature so that due to the effects of the temperature and/or pressure the first material and the second material advantageously diffuse into one another.

### BRIEF DESCRIPTION OF THE DRAWING FIGURES

Preferred embodiments of the invention shall be explained in greater detail in the following using the attached drawings.

FIG. 1 depicts a welding tool for friction stir welding;

FIG. 2 is an enlargement of part of the welding tool seen in FIG. 1;

FIG. 3 depicts a first embodiment of a pin for the welding tool in FIG. 1;

FIG. 4 depicts a second embodiment of a pin for the welding tool in FIG. 1;

FIG. 5 depicts a third embodiment of a pin for the welding tool in FIG. 1;

FIG. 6 depicts a fourth embodiment of a pin for the welding tool in FIG. 1;

FIG. 7 depicts a pin for the welding tool from FIG. 1 having a first outer geometry along a longitudinal axis of the pin;

FIG. 8 depicts a pin for the welding tool in FIG. 1 having a second outer geometry along the longitudinal axis of the pin;

FIG. 9 depicts a pin for the welding tool in FIG. 1 having a male thread;

FIG. 10 depicts a first sectional geometry of a pin for the welding tool in FIG. 1;

FIG. 11 depicts a second sectional geometry of the pin for the welding tool in FIG. 1;

FIG. 12 depicts a wave-shaped positive fit connection between a first pin region and a second pin region of the pin in FIG. 3 through FIG. 11;

FIG. 13 depicts a zigzag positive fit connection between the first pin region and the second pin region;

FIG. 14 depicts a positive fit connection between first and second pin regions with notches; and,

FIG. 15 depicts a pin, wherein material from the first pin region is diffused into the second pin region and vice versa.

### DETAILED DESCRIPTION

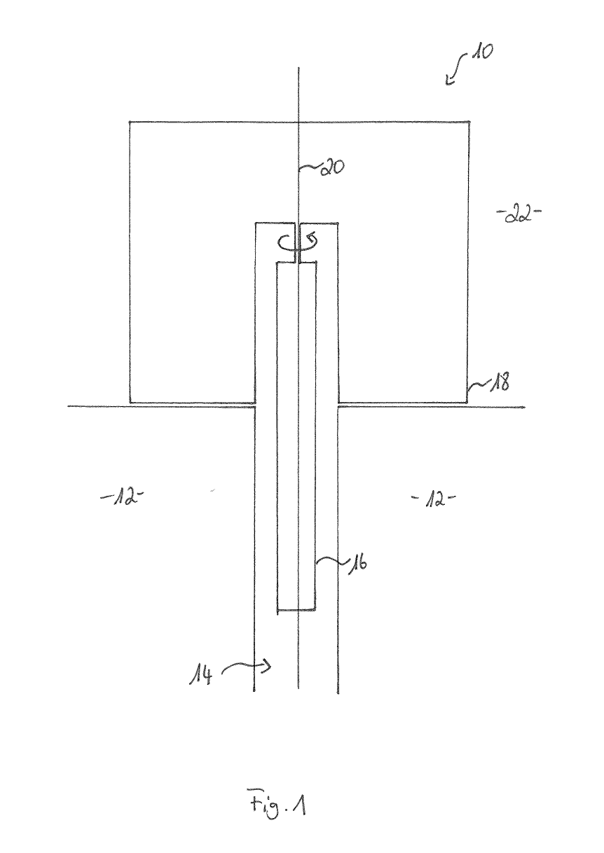

FIG. 1 depicts a welding tool 10 for friction stir welding and with which two workpieces 12 may be joined to one another in a joining region 14.

The welding tool 10 has a pin 16 and a shoulder 18 surrounding the pin 16. The pin 16 is held so that it is rotatable about a longitudinal axis 20 and extends along the longitudinal axis 20 into the joining region 14 for the two workpieces 12. The frictional heat is applied to the workpieces 12 using the rotation of the pin 16 so that the material of the workpieces 12 plasticizes, shears around the pin 16, and thus forms a weld seam (not shown). The shoulder 18 separates the joining region 14 and the pin 16 from the surroundings 22 and thus prevents for instance disadvantageous interaction of the oxygen present in the surrounding air with the plasticized materials of the workpieces 12 or with the surface of the pin 16.

FIG. 2 depicts a detail of the pin 16 from FIG. 1. The pin 16 has a first pin region 24 and a second pin region 26. The first pin region 24 is made of a first material 28 and the second pin region 26 is made of a second material 30. The first material 28 is selected such that the first pin region 24 forms a support region 32 in order to thus stabilize the pin 16 against forces and/or torques acting from the outside and therefore against deformation.

The second material 30 is selected such that the second pin region 26 has a friction region 34 that applies frictional heat to the workpieces 12 in order to thus plasticize the latter in the joining region 14. In particular the second material 30 is arranged on an outer surface 36 of the pin 16 and thus forms a friction surface 38.

The E modulus of the first material 28 is higher than the E modulus of the second material 30; the difference is preferably 20% to 50%. Thus the first material 28 is higher strength than the second material 30. In order to avoid the second material 30 fusing below the operating temperature, about 500° C., the second material 30 is heat-resistant and toughened and is also heat-conducting.

The first material 28 is formed with a ceramic 40, for instance with Si₃N₄—Y₂O₃. The second material 30 includes a metal composite 42, for instance MP 159.

If the first material 28 also has a higher coefficient of thermal expansion than the second material 30 so that it expands more at operating temperature than the second material 30 and stabilizes the pin 16 particularly well.

FIG. 3 through FIG. 6 depict different embodiments of the pin 16 with the two pin regions 24, 26.

In a first embodiment, depicted in FIG. 3, the first pin region 24 is arranged inside the second pin region 26 and extends across the entire length of the pin 16.

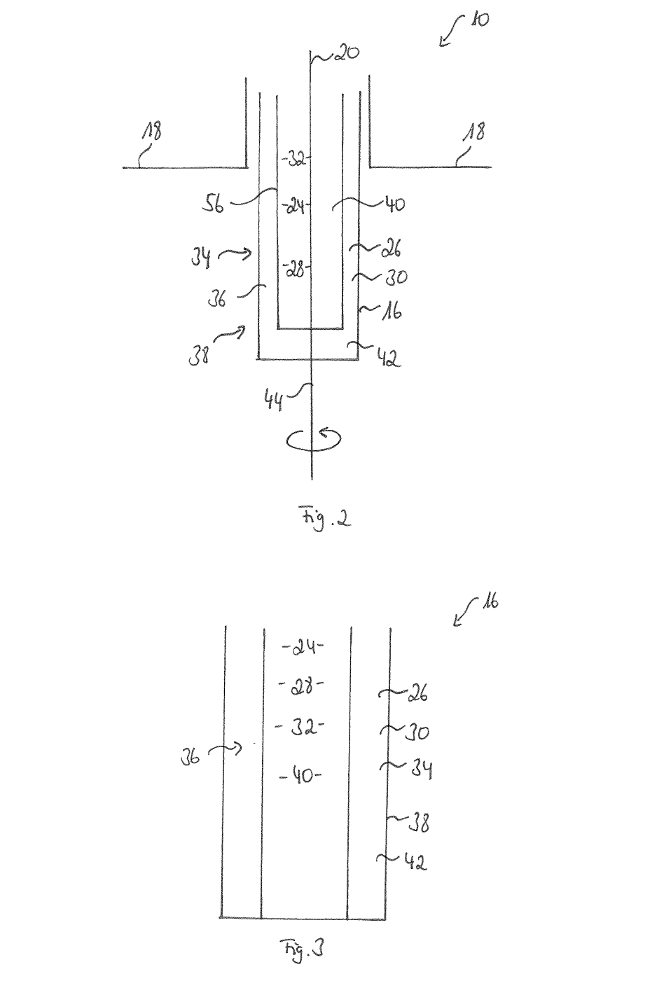

In a second embodiment, depicted in FIG. 4, a plurality of first pin regions 24 are provided in the pin 16. A first partial pin region 46 extending across the entire length of the pin 16 is arranged along a center axis 44 of the pin 16. Arranged spaced apart from the first partial pin region 46 are two or four second partial pin regions 48 extending across only a sub-region 50 of the longitudinal axis 20 of the pin 16. This ensures particularly good stabilization in the sub-region 50 of the pin 16.

A third embodiment of the pin 16, depicted in FIG. 5, depicts an arrangement of four first partial pin regions 46 arranged symmetrically around the longitudinal axis 20 and that extend across the entire length of the pin 16.

In a fourth embodiment of the pin, depicted in FIG. 6, the first pin region 24 is merely arranged in the upper sub-region 50 of the pin 16, and specifically where, under processing conditions, the pin 16 could strike the shoulder 18. Thus protection against distortion is provided only in this region in order to be able to save material and manufacturing costs in this manner.

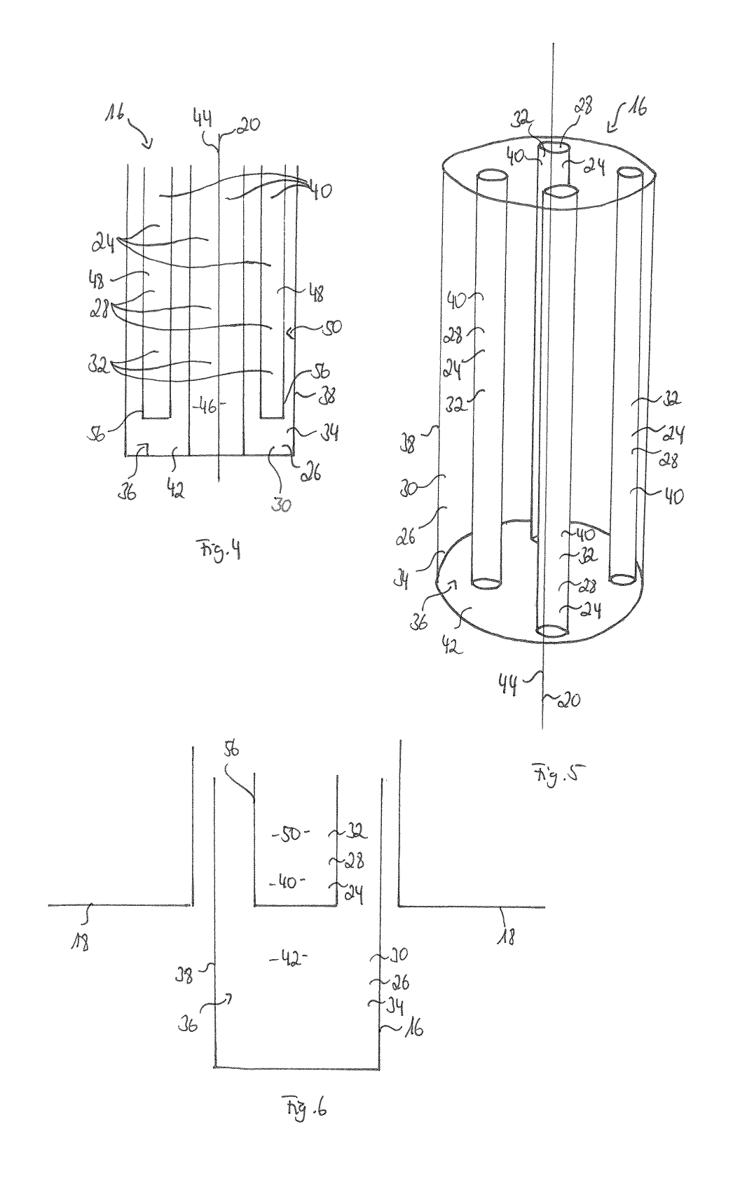

FIG. 7 through FIG. 11 depict various outer geometries of the pin 16, which geometries may be used in the welding tool 10.

FIG. 7 depicts one embodiment in which both the first pin region 24 and the second pin region 26 are embodied in a conical shape and therefore the pin 16 is also embodied in a conical shape.

In the embodiment in FIG. 8, the first pin region 24 is embodied in a cylindrical shape, while the second pin region 26, and thus the outer geometry of the pin, is formed in a conical shape.

FIG. 9 depicts an embodiment in which the pin 16 has a male thread 52.

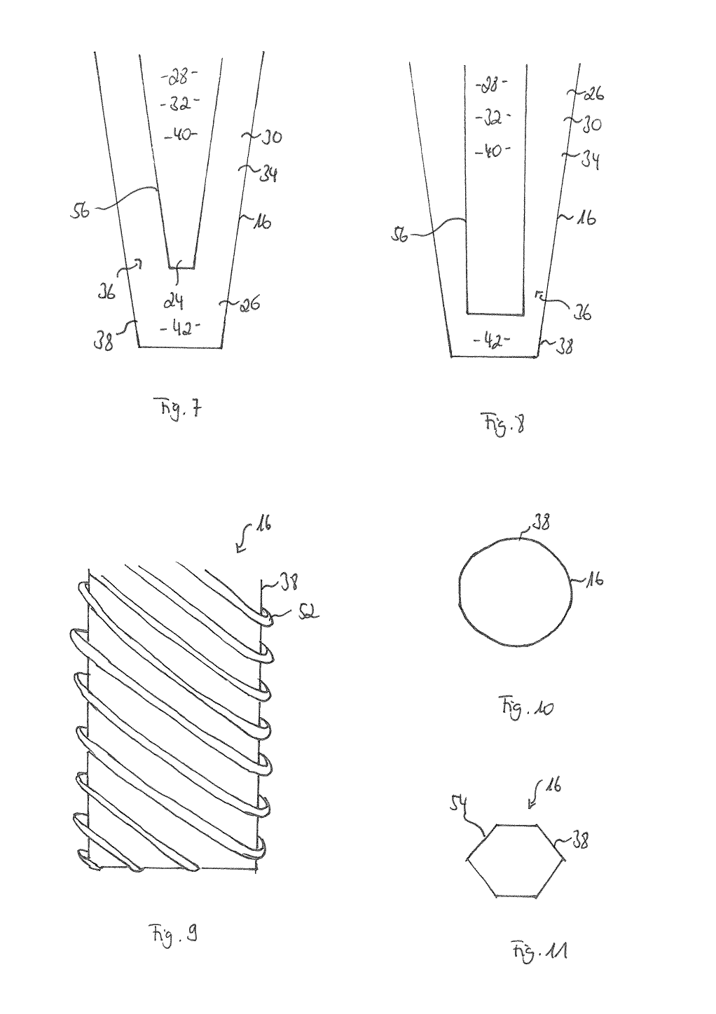

FIG. 10 and FIG. 11 depict cross-sectional geometries of the pin 16. In the embodiment in FIG. 10, the pin 16 is embodied round, while in the embodiment in FIG. 11 it has a polygonal outer geometry 54.

FIG. 12 through FIG. 15 depict embodiments in which the first and second pin regions 24, 26 are held to one another in a positive and/or material bond. The first pin region 24 is inserted into a sac-like recess 56 in the second pin region 26.

In a first embodiment of a positive fit connection of the two pin regions 24, 26, depicted in FIG. 12, a wave shape 58 of the two pin regions 24, 26 is provided.

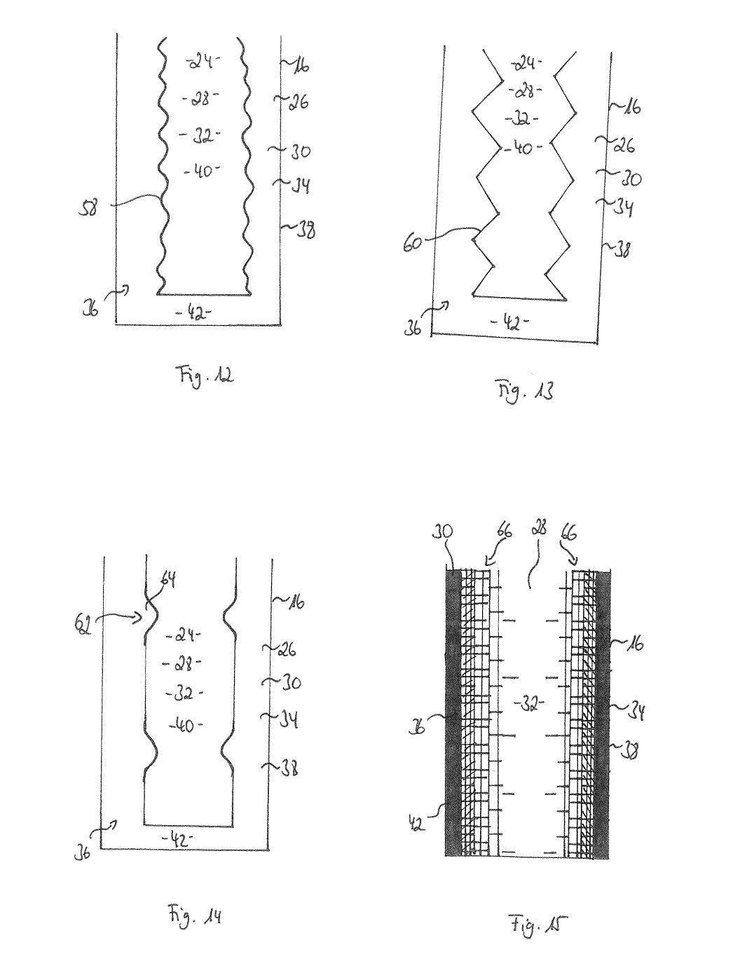

In a second embodiment, depicted in FIG. 13, a zigzag shape 60 is provided instead of the wave shape 58.

Another embodiment, depicted in FIG. 14, has notches 62 in the first pin region 24 and projections 64 of the second pin region 26 engage therein.

FIG. 15 depicts that a material bond between the two pin regions 24, 26 may be produced in a diffusion region 66 using diffusion of the first material 28 into the second material 30 and vice versa.

In order to manufacture the pin 16 described in the foregoing, the two materials 28, 30 are provided and the pin 16 is formed in that the first material 28 is inserted into the second material 30.

This may occur in that first the second material 30 is heated, the first material 28 is surrounded with this heated second material 30, and then the two materials 28, 30 are cooled together to form the pin 16. The materials 28, 30 may also be pre-molded as depicted in FIG. 12 through FIG. 14 in order to be able to form a positive fit. After the first material 28 is inserted into the second material 30, the pin 16 may be acted upon with pressure and/or temperature to produce a diffusion profile as depicted in FIG. 15.

Alternative manufacture may occur using generative production, i.e. for instance using rapid prototyping or additive layer manufacturing.

The depicted embodiments of the pin 16, i.e. the outer geometry in the longitudinal extension and the sectional outer geometry, the presence of a male thread 52, the provision of one or a plurality of first pin regions 24, the extension of the first pin regions 24 along the entire length of the pin 16 or only in a sub-region 50 of the pin 16, may be provided alternatively or in combination with one another. In addition, the positive fit of the first and second pin regions 24, 26 may be effected using a combination of the options depicted in FIG. 12 through FIG. 14. Other contouring options are also possible.

Due to unsatisfactory wear and tool life of welding tools 10 in industrial use, an improved welding tool 10 is proposed. Until now, welding tools 10 have only been suitable for certain spectra of applications, but beyond these are less suitable; for instance this is true of functionally different welding tool variants.

Therefore now the potentials of a material composite, comprising an outer shell, the second pin region 26, for instance in a sac-like geometry, and an inner rod, the first pin region 24, shall be used, wherein the two pin regions 24, 26 are joined or positioned to one another. The geometries may also be conical.

The outer shell having the maximum flexural stresses in use is heat resistant and toughened and/or heat-conducting, the inner rod is higher strength and has a higher E modulus. Conductivity may be adjusted using the material selection. This creates a welding tool 10 having high capacity, longer wear, less elastic distortion, and the potential to design a more slender pin 16.

One possible way to manufacture the composite is joining by means of shrinking

The tool life indicates how long the pin 16 may be used, for instance when welding long seams the pin lasts e.g. 500 min.

The wear is a function of use, for instance when used for a plurality of and different weld seams, depending on the length of the seams, the thickness of the plates, or when used for weld seams of the same type.

The capacity is the behavior of the pin 16 given the effects of external forces, torques, and temperature, which depend on the material to be welded.

The technical problem is to provide a pin 16 that has less deformation under process load than has been known in the past, i.e. wherein the phenomenon of distortion is prevented. In the past this has been attained using a thick pin 16. Now a different approach, in which the pin 16 is stiffened, has been chosen.

There are materials with which there have been attempts to address the aforesaid problem, for instance described in US patent document U.S. Pat. No. 7,401,723 B2 for pins 16 having a free end and a shoulder 18. One such material is for instance MP 159, which for instance is also used in heat-resistant screwing in automobile construction. For a tool having a double shoulder 18, a so-called bobbin-tool or self-reacting tool, for instance described in US patent document US 2006065694 A1, the load on the pin 16 is lower because the lower shoulder 18 also rotates with it, but this may only be used for weld seams having a length of a few centimeters. Thus such a welding tool 10 is not suitable for industrial use. Until now pins 16 have been produced from only one material or one alloy.

We are now departing from this idea in that the pin 16 is manufactured from two different materials as a composite.

Not every material is suitable for a pin for all applications, i.e. for long and short weld seams or for thick and thin plates.

A ceramic 40, for instance Si₃N₄—Y₂O₃, is used as the inner material for the first pin region 24. This material has an E modulus of about 310 GPa, both at room temperature and at an operating temperature of about 500° C.

Outer materials that may be used include MP 159, TSP 1, NiCo compounds such as Inconel, or materials for engines, nickel compounds, and/or cobalt compounds, and inexpensive tool steel such as hot work tool steel and high-speed steel.

The properties of the inner material at operating temperature are for instance as for aluminum or magnesium.

MP159 is an expensive material that is not very available, so in this case thought must be given to whether one of the other aforesaid materials can also at least approximately satisfy the requirements. Inconel is softer than MP 159, and inexpensive tool steels such as hot work tool steel 1.2344 and high-speed steel 1.3343 are also cost-effective alternatives to MP 159.

The properties of the pin 16 remain as in the past; specifically it is heat-resistant at operating temperature and thus has better or the same properties as at room temperature and is also toughened, and thus at working temperature it has a long elongation at rupture so that the pin 16 may continue to be used despite a rupture. In addition, the outer material has a metal character with a high friction coefficient. Metal compounds 42 are preferred, since they have better heat dissipation.

Such a described pin 16 withstands high outside forces.

It is also possible to imagine using at least two materials, wherein the outer material is embodied as described above and the inner material has a higher coefficient of heat expansion than the outer material. Thus it expands at operating temperature and produces an outward radial force. Materials such as light metals, aluminum, and steel may be used in this case, for instance.

During the manufacture of the pin 16, either a shrink method is selected, wherein the outer hot part is laid over the for instance ceramic part and both are cooled together. Alternatively, generative production, i.e. rapid prototyping or additive layer manufacturing or the like, may be used to manufacture the pin 16.

A conical shape for the pin 16 has the advantage of a high bending moment with a large cross-section, better heat flow from the bottom to the top through the pin 16, and simple manufacture. However, only a cylindrical-conical form is possible, even with contouring of the pin 16, for instance as a hexagon, with thread 52, etc. In order to connect the inner part to the outer part, a positive fit may be provided in which ribbing, a notch arm, waves, or soft contouring is provided, wherein the outer part must be worked with broaching tools for connecting to the inner part. Alternatively or in addition, a material bond may also be provided in which diffusion between the outer part and the inner part is effected using temperature and/or pressure.

Multiple inner parts may also be arranged symmetrically, for instance four inner parts of equal length or one long inner part that extends through the entire pin 16 and two or four shorter inner parts in the upper region of the pin 16, for providing reinforcement at the location with the highest load. For instance, a ceramic reinforcement must include at least the depth or location in the pin 16 that experiences the greatest bending load in the welding process.

Inexpensive outer material and ceramic 40 as the inner part lead to a pin 16 having properties like previously known pins 16 or a monolith. The outer material may be made of hot work tool steels or high-speed steels such as TSP 1.

Because of this it is possible to produce slimmer pins 16 compared to pins 16 known in the past. This is advantageous for instance in plate welding. There is the possibility of adjusting the design in that, in contrast to what has been known in the past, the higher capacity is not used to extend the service life but rather to make the diameter more slender. Another advantage is the reduction in process forces, i.e. the force when advancing or a vertically acting force, since a smaller pin 16 leads to a smaller shoulder 18 and thus overall to reduced process forces.

Thus, a hybrid pin 16 is proposed that has a first pin region 24 that is heat-resistant and/or toughened, for instance made of metal, and that has a second pin region 26 that is higher strength and has a high E modulus, for instance a ceramic 40. Alternatively, a light metal may be used that expands with the effects of process heat.

Thus, the pin 16 withstands higher outer forces, has a higher capacity, longer wear, may be embodied more slender, and in addition has less distortion.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### REFERENCE LIST

10 Welding tool
12 Workpiece
14 Joining region
16 Pin
18 Shoulder
20 Longitudinal axis
22 Surroundings
24 First pin region
26 Second pin region
28 First material
30 Second material
32 Support region
34 Friction region
36 Outer surface
38 Friction surface
40 Ceramic
42 Material composite
44 Center axis
46 First partial pin region
48 Second partial pin region
50 Sub-region
52 Male thread
54 Polygonal outer geometry
56 Sac-like recess
58 Wave shape
60 Zigzag shape
62 Notch
64 Projection
66 Diffusion region

1-15. (canceled)

16. A friction stir welding tool for joining at least two workpieces, the friction stir welding tool comprising:
a pin configured to apply frictional heat to the at least two workpieces during friction stir welding,
wherein the pin includes a first pin region formed from a first material and a second pin region formed from a second material.

17. The friction stir welding tool of claim 16, wherein
the first pin region has a support region for supporting the pin during the friction stir welding,
the second pin region has a friction surface configured to apply frictional heat to the at least two workpieces.

18. The friction stir welding tool of claim 16, wherein
the first material has a higher E modulus than the second material, or
the first material has a higher strength than the second material,
wherein the second material is heat-resistant, toughened, or heat-conducting.

19. The friction stir welding tool of claim 18, wherein the first material has a higher E modulus that is greater than the second material by 20%-50%.

20. The friction stir welding tool of claim 16, wherein
the first material is formed with ceramic that is Si₂N₄—Y₂O₃ or ZrO₂—Y₂O₃, or
the second material is an MP 159 metal composite.

21. The friction stir welding tool of claim 16, wherein the first material has a higher coefficient of thermal expansion than the second material.

22. The friction stir welding tool of claim 16, wherein the pin extends along a longitudinal axis of the welding tool and a shoulder that surrounds the pin is provided for separating a joining region of the workpieces from surroundings, wherein the pin is held so that it rotates about the longitudinal axis.

23. The friction stir welding tool of claim 16, wherein
the first pin region and the second pin region are arranged rotationally symmetrical about a longitudinal axis, and
the first pin region extends along an entire longitudinal axis of the pin or extends in a sub-region along the longitudinal axis in which a greatest bending load during friction stir welding is to be expected.

24. The friction stir welding tool of claim 16, wherein the first pin region is arranged in a sac-like recess of the second pin region.

25. The friction stir welding tool of claim 16, wherein the tool comprises a plurality of first pin regions.

26. The friction stir welding tool of claim 16, wherein
the pin has a longer longitudinal extension length than diameter,
the first pin region or the second pin region have a conical or cylinder shape, or
the pin has a polygonal outer geometry or a male thread.

27. The friction stir welding tool of claim 16, wherein the first pin region and the second pin region are held to one another in a positive fit or in a material bond.

28. The friction stir welding tool of claim 16, wherein
the first pin region has ribbing, at least one notch, a wave shape, or contouring, or
the first material and the second material are diffused into one another in a diffusion region of the pin.

29. A method for manufacturing a friction stir welding tool comprising:
a) providing a first material;
b) providing a second material; and
c) forming a pin by inserting the first material into the second material.

30. The method of claim 29, wherein
step c) comprises the steps of:
c1) heating the second material;
c2) surrounding the first material with the second material; and
c3) cooling the first material and the second material together,
in step c) the pin is formed using rapid prototyping, additive layer manufacturing, or hot isostatic pressing of powder.

31. The method of claim 29, wherein
in step a) the first material is premolded, and contouring, ribbing, at least one notch, or a wave shape is formed on the premold, or
in step c) the pin is acted upon with elevated pressure or elevated temperature.
